(19) United States
(12) Patent Application Publication
(10) Pub. No.: US 2006/0077572 A1
(43) Pub. Date: Apr. 13, 2006

(54) Split optic support structure and optical system using split optic support structure

(75) Inventors: Livyn O. Okorocha, Cincinnati, OH (US); Brian H. Welham, Cincinnati, OH (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/964,468

(22) Filed: Oct. 13, 2004

(51) Int. Cl. G02B 7/02

(52) U.S. Cl. 359/819

(57) ABSTRACT

An optical system includes an optic support structure having a hollow interior with a longitudinal central axis and an optic support surface extending around the longitudinal central axis. Seats for axial and/or vertical alignment of an optic are defined on the optic support surface. The axial alignment seats can contact an outer circumferential edge of the optic, and the transverse alignment seats can contact one face of the optic. A resilient member extending transverse to the longitudinal central axis can be configured to contact the outer circumferential edge of the optic. The resilient member can apply a biasing force against the optic in a direction generally transverse to the longitudinal central axis that can force the optic against the seats of the optic support surface.

### FIELD OF THE INVENTION

The present invention relates generally to optic support structures and optical systems using same and, more particularly, it relates to split optic support structures and optical systems using same.

### BACKGROUND OF THE INVENTION

Rear projection display systems include many individual components that cooperate to display an image for a viewer. For example, a rear projection display system typically includes a cabinet, a translucent screen on a viewing side of the cabinet, an image source disposed within the cabinet, and an optical system. The image source, typically a cathode ray tube (CRT) or a light valve, such as a liquid crystal on silicon device (LCOS) or a digital micromirror device (DMD), can be used to produce the image for projection. In the case where a light valve is used, it produces an image when illuminated by a light source. The optical system includes a plurality of optics in the form of mirrors and lenses configured to direct and focus the image onto the translucent screen. The optics are usually mounted in an optic mounting structure that positions the individual mirrors and lenses along an optical axis.

Assembly of the optics within the optic mounting structure has been a continuing challenge in terms of maintaining ease of assembly while also properly positioning the optics. The optics typically should be properly positioned within the optical system to ensure proper focus and to prevent any movement of the optics relative to the optical mounting structure during transit and use. Two approaches have been used for positioning the optics inside the mounting structure and securing the optics against movement after mounting.

One approach is to retain the optics within grooves or channels within the interior of the mounting structure. Annular side walls of these channels usually include raised pads that force the edge of the optic against an opposite wall of the channel. This creates an interference fit between the mounting structure and the optic. However, in typical examples of such traditional configurations, due to the rigid nature of the raised pads used to properly position the lens, and the rigid nature of the opposing wall, the assembly forces required to fully seat the optics within the groove or channel can be exceedingly high. Sometimes, high assembly force has required a specialized assembly fixture with the capability to generate high forces to seat the optics within the mounting structure. As a result, this can create high mechanical stress on the assembled optical system or even damage the optic.

Another approach is to replace the raised pads with flexible tab members spaced angularly about the channels in the mounting structure and to divide the mounting structure into two symmetrical shell halves that are assembled together after the optics are placed into the appropriate channels. The flexible tab members deflect outwardly when contacted by the outer circumferential edge of an optic during assembly of the mounting structure. This approach can provide an acceptable alternative solution to some of the difficulties presented by the use of raised pads alone. However, in typical examples of such traditional configurations, the optic is prone to unintentional misalignment when the shell halves are assembled unless the shell halves are precisely aligned, which may result in optic tip and image distortion.

Thus, there is a continuing need for optical systems, for example, for use in rear projection display systems, that address assembly difficulties and related focusing problems while being capable of maintaining relatively low cost and complexity associated with manufacturing the mounting structure for the optical system and assembling the optics with the mounting structure.

### SUMMARY OF THE INVENTION

According to one aspect of the present disclosure, it provides an optic support structure having a hollow interior with a longitudinal central axis and a support surface extending around the longitudinal central axis. A resilient member is carried by the optic support structure and is configured to contact an outer circumferential edge of an optic. The resilient member is moved outwardly by the contact transverse to the longitudinal central axis. At least one transverse alignment seat projects axially from the support surface and is positioned to contact an optic. The transverse alignment seats and the resilient member are configured to cooperate to secure an optic in the hollow interior of the optic support structure and position an optic transverse to the longitudinal central axis.

In another embodiment of the present disclosure, an optic support structure includes a hollow interior with a longitudinal central axis and a support surface extending around the longitudinal central axis. A resilient member carried by the optic support structure is configured to be moved outwardly transverse to the longitudinal central axis. Arranged about the support surface are first and second axial alignment seats that are configured to contact an optic. The first and second axial alignment seats are configured to cooperate with the resilient member to secure an optic against substantial movement in the hollow interior of the optic support structure and cooperate with the resilient member to axially position an optic relative to the annular support surface.

In another aspect of the present disclosure, an optic support structure further includes a focus mount including a driver element and a driven element operatively coupling the driver element with the optic support structure. The driven element is configured to move the optic support structure along the central longitudinal axis positioning the optic support structure relative to the focus mount.

In another aspect of the present disclosure, a method is provided for holding an optic inside an optic support structure having a longitudinal central axis, in which the optic has a first half and a second half defined by a longitudinal bisecting plane. The method comprises contacting the first half of the optic to position the optic in a direction transverse to the longitudinal central axis and also contacting the first half of the optic to position the optic in a direction parallel to the longitudinal central axis. The method further includes applying a force to the second half of the optic in the direction transverse to the longitudinal central axis for securing the optic against substantial movement relative to the optic support structure.

Advantages and features of the present invention will become more readily apparent to those of ordinary skill in the art upon review of the following detailed description of exemplary embodiments, taken in conjunction with the accompanying drawings.

### BRIEF DESCRIPTION OF THE DRAWINGS

FIG. 1 is a perspective view of an exemplary optical system constructed in accordance with the present invention.

FIG. 2 is another perspective view of the exemplary optical system of FIG. 1, constructed in accordance with the present invention.

FIG. 3 is an exploded view of the optical system of FIG. 1.

FIG. 4 is a disassembled perspective view showing a first housing of the optic support structure for the optical system of FIG. 1 with the optics removed.

FIG. 4A is a detailed view of the encircled portion 4A shown in FIG. 4.

FIG. 5 is another disassembled perspective view similar to FIG. 4 of the first housing.

FIG. 5A is a detailed view of the encircled portion 5A shown in FIG. 5.

FIG. 6 is a cross-sectional view taken along line 6-6 in FIG. 2 without the focus mount.

FIG. 6A is a detailed enlarged view of the encircled portion 6A shown in FIG. 6.

FIG. 7 is a cross-sectional view taken along line 7-7 in FIG. 1 without the focus mount.

FIG. 7A is a detailed enlarged view of the encircled portion 7A shown in FIG. 7.

FIG. 8 is a disassembled perspective view of the second housing of the optic support structure for the lens system of FIG. 1 without the optics.

FIG. 9 is an enlarged cross-sectional view of a resilient mounting member of the present invention without the optic.

FIG. 10 is an enlarged cross sectional view similar to FIG. 9 in which the optic is assembled with the optic support structure and resilient member.

FIG. 11 is a cross-sectional view taken generally along line 11-11 of FIG. 1.

FIG. 11A is a detailed enlarged view of the encircled portion 11A shown in FIG. 11.

### DETAILED DESCRIPTION

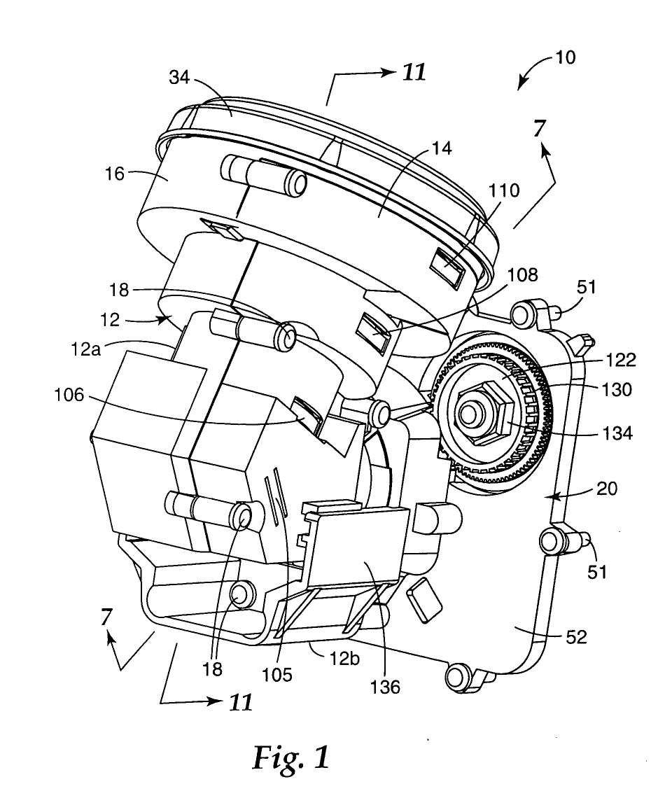

With reference to FIGS. 1-3, an optical system 10 is constructed in accordance with one exemplary embodiment of the present invention, although it will be understood that other configurations are contemplated by the present invention. The optical system 10 is specifically suitable for use in rear projection display systems but may also be used in a front projection display system. The optical system 10 will typically be used in conjunction with an image source or light source 13, such as a digital micromirror device (DMD), that supplies a series of images associated with one of the colors red, green or blue for projection at a non-perpendicular angle onto a projection screen. However, the optical system 10 may also include any other light or image source 13, including but not limited to a cathode ray tube (CRT) or a liquid crystal on silicon device (LCoS), capable of serially and continuously producing images for projection onto a projection screen.

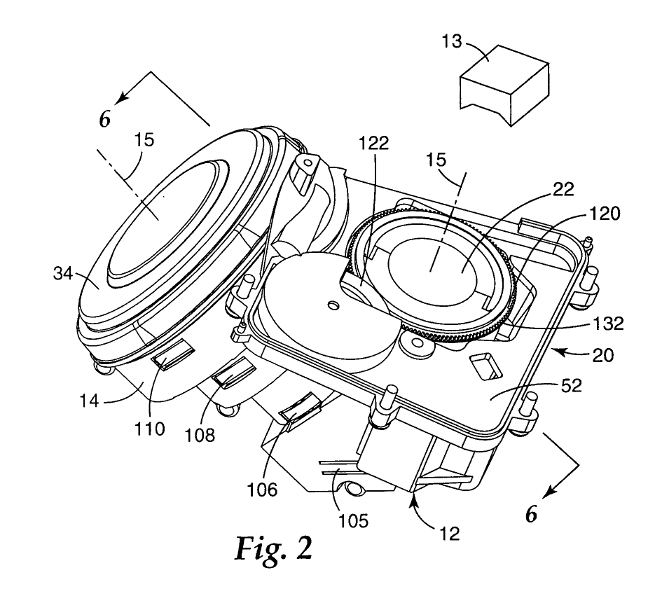

An exemplary optic support structure or lens cell 12 of the optical system 10 includes asymmetrically-shaped first and second housings 14; 16 and a focus mount 20 coupled mechanically with the housings 14, 16, as described below. The first and second housings 14, 16, which may be injection molded plastic structures, are joined together, for example, with conventional fasteners 18 during assembly of the optical system 10 and define the hollow interior of the lens cell 12 when assembled. As illustrated in FIGS. 2, 3 and 6, situated inside the hollow interior of lens cell 12 and secured at specified locations between the housings 14, 16 may be one or more optics 22, 24, 26, 28, 30, 32, a lens cap 34, an aperture 36, and a mirror 38. One or more of the optics 22, 24, 26, 28, 30, 32 may be a lens (i.e., optical element) or a lens combination, such as a cemented lens combination, (i.e., optical component). Mirror 38 usually has a conventional reflective construction understood by persons of ordinary skill in the art.

As it can be seen in FIGS. 1, 2, 3 and 6, optics 22, 24, 26 are positioned at spaced-apart mounting locations in one arm 12b of the lens cell 12. Similarly, optics 28, 30, and 32 are positioned at spaced-apart mounting locations in a second arm 12a of the lens cell 12 that depends at an angle from first arm 12a. Optics 22, 24, 26, 28, 30, 32, aperture 36, and mirror 38 are aligned generally along segments of a longitudinal axis 15 (FIG. 2) of the lens cell 12. The segments of the longitudinal axis 15 may be non-collinear, with a first linear segment extending centrally through arm 12a and a second linear segment extending centrally through arm 12b. Longitudinal axis 15 may coincide with an optical axis of the lens cell 12 along which light travels in lens cell 12.

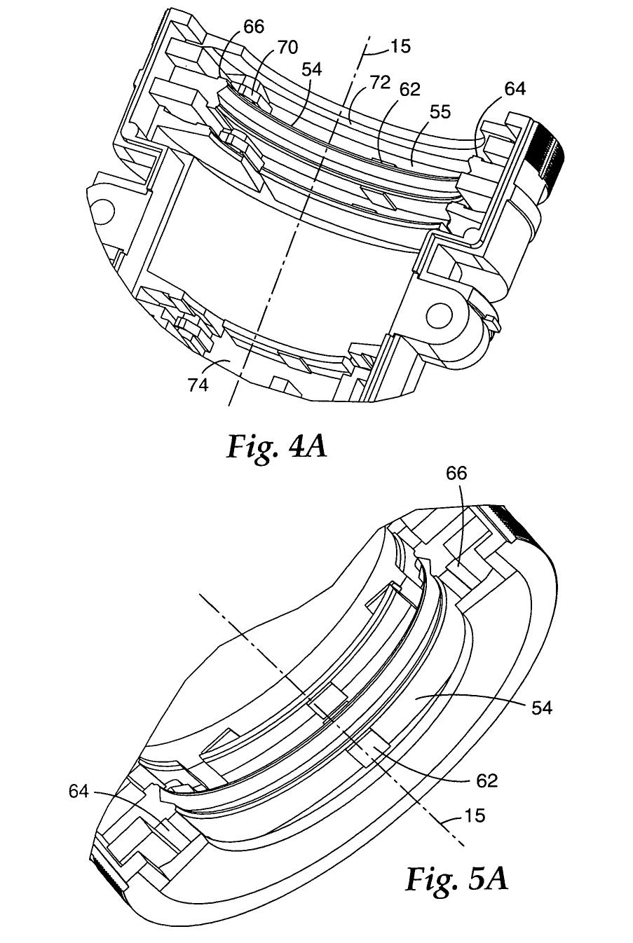

Optic 22 receives a continuous series of images output by a light source or image source 13 and directed toward an entry face 56 (FIG. 6) of the optic 22. As the light from light or image source 13 propagates along longitudinal axis 15 inside arm 12b, the constituent images are manipulated by optics 24 and 26, clipped by an aperture 36, for example to reduce the effects of unwanted stray light, and reflected by mirror 38 towards the confronting entry face of optic 28 in arm 12a. Mirror 38 changes the direction of light by reflection to accommodate the angulation of the lens cell 12. After image reflection, optics 28, 30 and 32 further manipulate the images as the light propagates along longitudinal axis 15 in arm 12a. The images are ultimately projected from optic 32 towards a projection screen (not shown). It is understood that lens cap 34 is removed from the lens cell 12 when mounted in a rear projection display system or another suitable system.

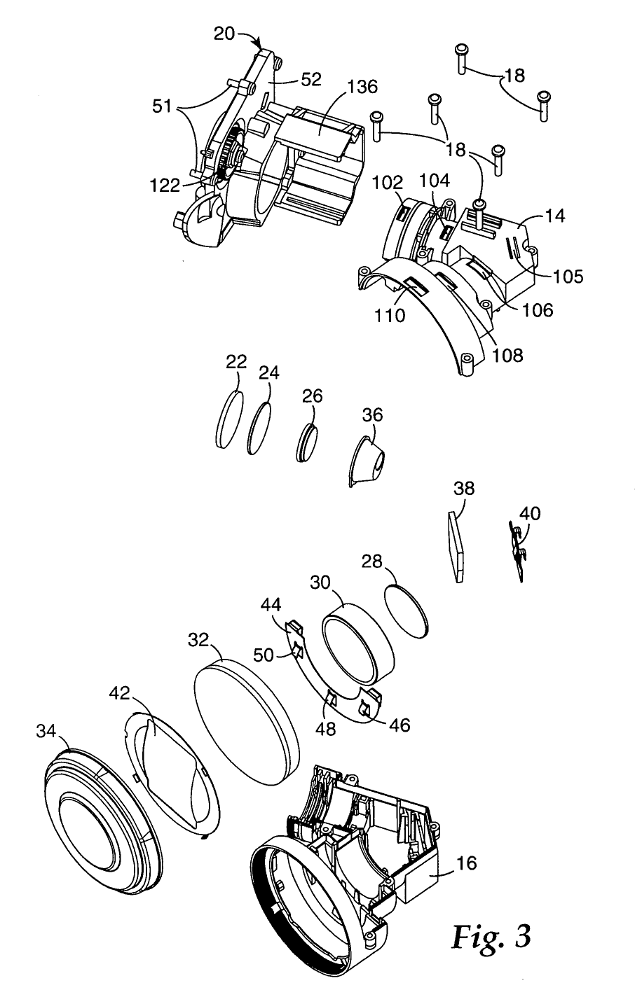

The optics 22, 24, 26, 28, 30, 32, aperture 36, and mirror 38 typically have fixed and stationary locations relative to the lens cell 12. Mirror 38 is biased axially against its mount by a spring plate 40 to define a stable and certain location relative to the neighboring optics 26 and 28. A reticle or mask 42 may clip at least some unwanted light, such as unwanted stray light, after passage through optic 32 and before projection. Positioned in the housing 16 is an insert 44 with three transverse alignment seats 46, 48, 50 (shown in FIG. 3) that define three points of contact and, thereby, that can cooperate to provide vertical alignment of optic 32 within its mount, as described below.

The focus mount 20 (shown in FIGS. 1, 2 and 3) is fastened with structure on the interior of the rear projection display system (not shown) by securing a flange 52 of the mount 20 with a portion of the rear projection display system using fasteners 51. The focus mount 20 can be used for axially moving the lens cell 12 toward or away from the light or image source 13 (shown in FIG. 2) to adjust the spacing between optic 22 and the light or image source 13. This represents an initial focus adjustment typically made at the factory during the manufacturing process to focus the image emitted from the optical system 10 on the projection screen.

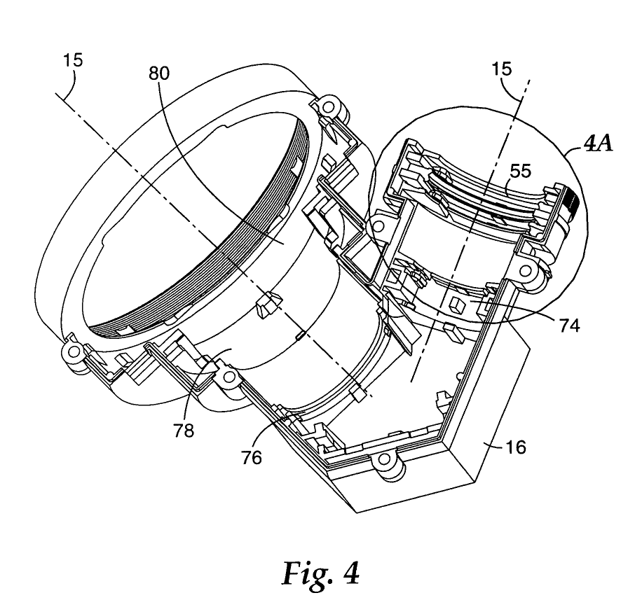

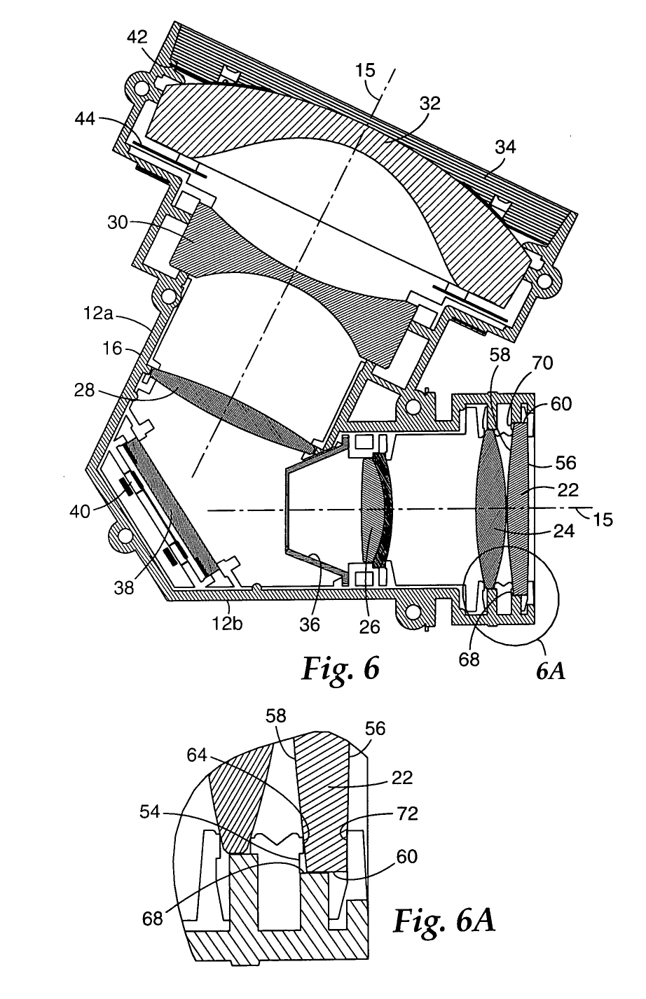

With reference to FIGS. 4, 4A, 5, 5A, 6, 6A, 7 and 7A, one or more of the optics 22, 24, 26, 28, 30, and 32 may be provided with three vertical or transverse alignment seats and two axial alignment features or seats that are situated in respective annular mounts or support surfaces defined inside the housing 16 at locations spaced axially along the longitudinal axis 15. Pressing an optic against one feature could, in some exemplary embodiments, set the position along the axis, as long as the transverse alignment seats assure that the optic is also in a plane transverse to the axis 15. The axial and transverse alignment seats for one or more of the optics 22, 24, 26, 28, 30, and 32 may be configured similarly. Thus, the following detailed description and view for the seats contacting optic 22, when the housings 14, 16 are assembled with optic 22 in position and secured, for example with fasteners 18 (FIG. 1), can apply equally to the seats contacting the other optics 24, 26, 28, 30, and 32, which may be included in some exemplary embodiments.

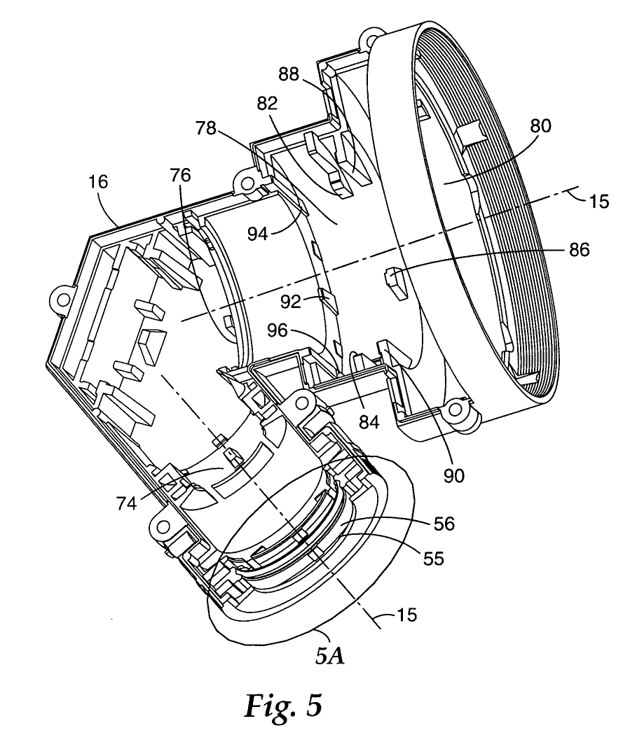

Projecting from an annular support surface 54 of an annular groove 55 (FIG. 4A), which extends about the longitudinal axis 15, are spaced-apart vertical or transverse alignment seats 62, 64, 66 (FIG. 4A, 5A) that are adapted to support optic 22. Portions of support surface 54 and groove 55 are carried by both housings 14, 16. In the exemplary embodiment shown, the central transverse alignment seat 62 is flanked by transverse alignment seats 64 and 66, which are preferably equidistantly spaced on opposite sides of transverse alignment seat 62. Optic 22 (FIG. 6A) has first and second faces 56 and 58 connected peripherally by an outer circumferential edge 60. In this exemplary embodiment, a portion of each of the transverse alignment seats 62, 64, 66 (FIG. 5A) contacts face 58 of optic 22 (FIG. 6A) and seats 62, 64, 66 operate collectively to define the vertical position of the optic 22 relative to the housings 14, 16 and transverse to longitudinal axis 15. These three contact points establish a plane against which the optic 22 securely registers and fix the optic 22 relative to the plane of the annular support surface 54.

The groove 55 may further include axial alignment seats 68, 70 (FIGS. 6, 6A, 4A) that contact the outer circumferential edge 60 of optic 22. The axial alignment seats 68, 70 are preferably equidistant from the central transverse alignment seat 62 and, preferably, are angularly spaced from each other by about 120°. When housings 14, 16 are in contact, the axial alignment seats 68, 70 cooperate with resilient member 102 to press optic 22 against another support surface 72 of groove 55, which may be an annular surface, opposite the support surface 54, which also may be an annular surface, for defining a position along longitudinal axis 15 of the optic 22 relative to the housings 14, 16 and relative to the support surfaces 54, 72, as determined by transverse alignment seats 62, 64, 66. The resilient member 102 (FIG. 3, 8) may be located about 120 degrees from each of the axial alignment seats 68 and 70 to seat an optic such that the optic's axis lies approximately on the longitudinal axis 15.

Optics 24, 26, 28, 30, and 32 in turn can be supported in a corresponding one of annular grooves 55, 74, 76, 78, and 80 (shown in FIGS. 4 and 5) defined inside the lens cell 12 on housings 14, 16 in a manner similar to optic 22. For example, groove 78 (FIG. 5) includes axial alignment seats 82, 84, and a set of transverse alignment seats 92, 94, 96, as visible in FIG. 5. Groove 78 also includes a set of tabs 86, 88, 90 (shown in FIG. 5) that axially bias the optic 30 (shown in FIG. 6). As described above and shown in FIG. 3, the transverse alignment seats 46, 48, 50 for optic 32 can be positioned on a removable insert 44 and, therefore, usually are not formed in the housing 14 during injection molding.

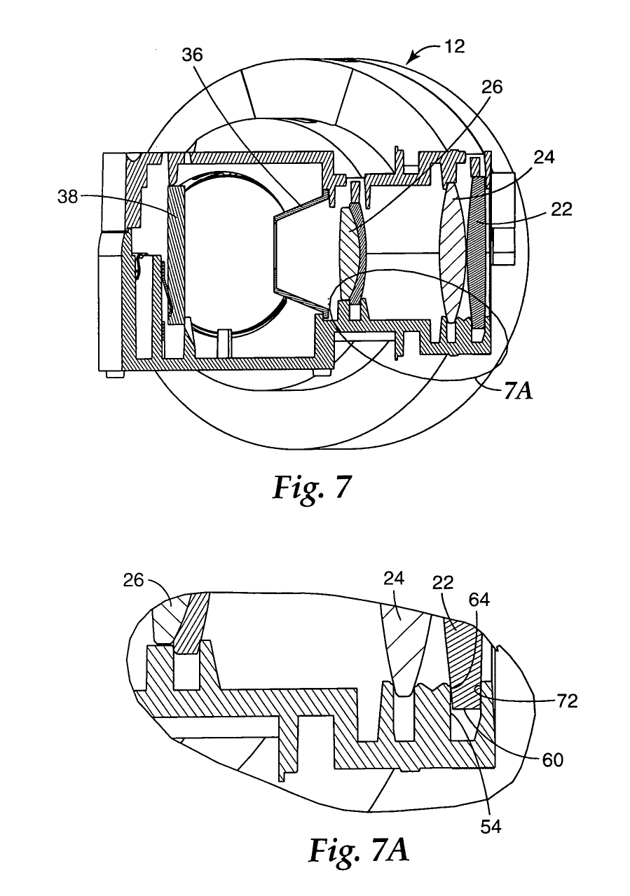

With reference to FIGS. 8, 9 and 10, provided on the housing 14 of an exemplary lens cell 12 are resilient tabs or members 102, 104, 105, 106, 108, 110 that can, for example, take the form of cantilevers movable generally radially outward and radially inward with respect to the longitudinal axis 15. Resilient member 105 is configured to contact an edge of mirror 38, whereas resilient members 102, 104, 106, 108, 110 are configured to contact an outer circumferential side edge of a corresponding one of the optics 22, 24, 26, 28, 30, and 32. Housing 14 and some or all associated resilient members 102, 104, 105, 106, 108, 110 may be integrally molded from polycarbonate or other suitable injection moldable material, for example using an injection molding process. Each of the resilient members 102, 104, 105, 106, 108, 110 may be configured identically and, therefore, a detailed description and view of one resilient member 102 can, in some embodiments, apply equally to the other resilient members 104, 105, 106, 108, 110.

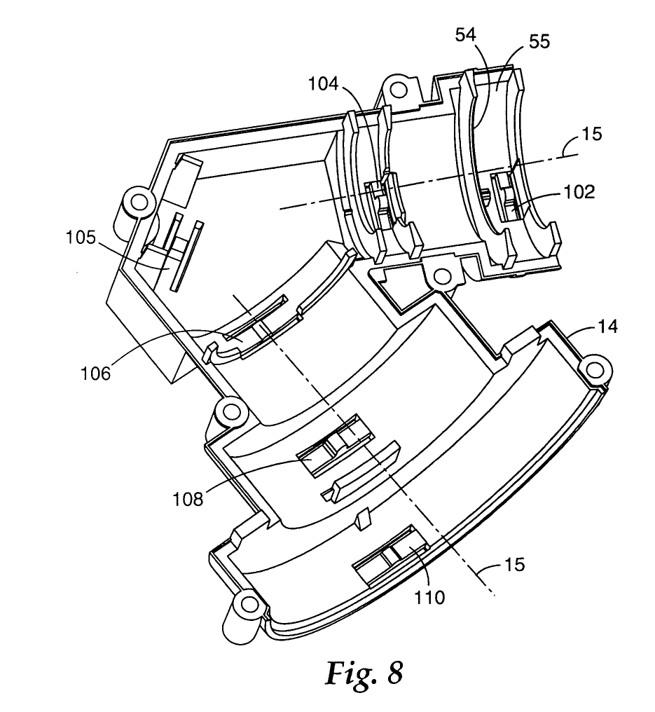

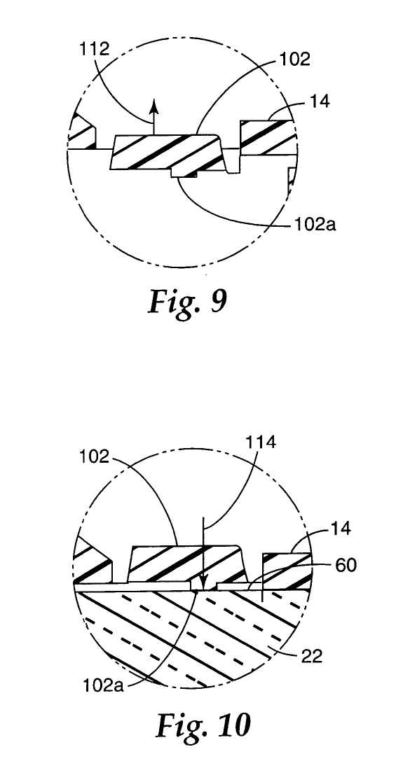

As particularly shown in FIGS. 8 and 9, a resilient member 102 protruding into groove 55 is configured to contact the first optic 22 and to be moved by the contact in a radially outward direction, as indicated by single-headed arrow 112 in FIG. 9. Resilient member 102 includes a projection 102a that can be configured to contact the outer circumferential edge 60 of optic 22 (FIG. 10). Preferably, the projection 102a of resilient member 102 is positioned in vertical alignment with, or diametrically across from, the transverse alignment seat 62 (shown in FIGS. 4A and 5A).

Resilient member 102 is normally disposed in the position shown in FIG. 9, but it may be moved in a direction indicated by single-headed arrow 112 against a counteracting radially inward directed biasing force. Thus, when optic 22 is inserted into lens cell 12 during assembly of the optical system 10, resilient member 102 can be moved radially outward to the position shown in FIG. 10 thereby exerting a radially inward or transverse force in the direction of a single headed arrow 114 against a circumferential edge 60. This facilitates an interference fit of optic 22 in lens cell 12 by forcing the optic 22 against the transverse alignment seats 62, 64, 66 and the axial alignment seats 68, 70, which cooperate to secure optic 22 against substantial movement in the hollow interior of the optic support structure or lens cell 12 defined inside the joined housings 14, 16. The resilient member 102 may be attached at both ends to the housing 14 or it may have a cantilevered attachment at only one end with housing 14.

The resilient member 102 may be any member, such as a metal spring, a separate rubber or another elastomeric insert, or a molded rubber or elastomeric member, that facilitates the intended biasing function and that supplies the primary spring load or retention force for optic 22. As shown in FIGS. 8, 9 and 10, the preferred structure for resilient member 102 is a flexible member in the form of a cantilever, but it can have another suitable shape. The resilient member 102 can be molded into a wall of the housing 14 to define a portion of the groove 55 in which the optic 22 can sit. The transverse alignment seats 62, 64, 66 (FIG. 5A) and the resilient member 102 thus cooperate to secure the optic 22 in the hollow interior of the lens cell 12 and to align the optic 22 transverse to the longitudinal central axis 15. The resilient member 102 further cooperates with the axial alignment seats 68, 70 (FIGS. 6, 6A) for securing the optic 22 against substantial movement inside the lens cell 12 and for aligning the axis of the optic 12 relative to longitudinal axis 15, to the annular support surface 54 (FIGS. 5, 5A) and also relative to the adjacent optic 24.

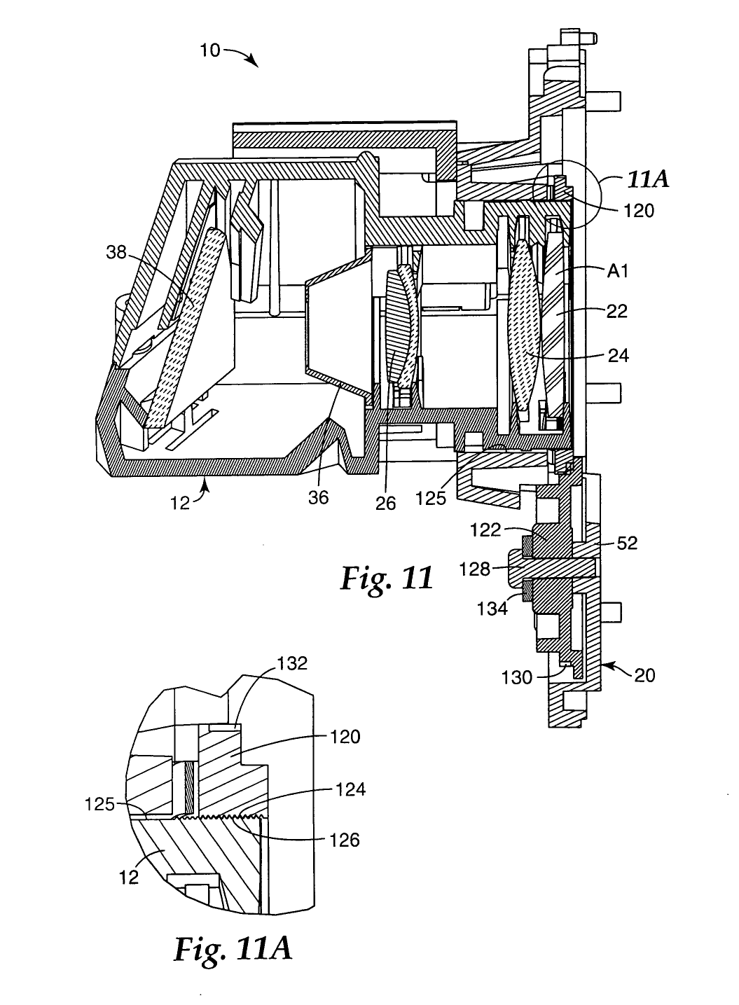

With reference to FIGS. 3, 11 and 11A, the lens cell 12, including optics 22, 24, 26, 28, 30, 32 and mirror 38, which are at all times stationary relative to the lens cell 12 and at fixed relative positions along longitudinal axis 15 during a focusing procedure, may be manually adjusted in an axial manner in left and right directions, as illustrated in FIG. 11, relative to the flange 52 (FIG. 3) of focus mount 20. To facilitate this positional adjustment, the focus mount 20 includes a rotatable driven element, illustrated in FIGS. 2 and 11 as a barrel 120, driven by a driver element, illustrated as a wheel 122, for moving the lens cell 12 axially relative to the focus mount 20. This focusing operation also adjusts the position of the lens cell 12 relative to the light or image source 13 (FIG. 2) and axially relative to the direction of light propagation of images in arm 12b of lens cell 12.

As best shown in FIG. 11A, the barrel 120 and the lens cell 12 are operatively coupled by a threaded engagement in which an internally threaded portion 124 of barrel 120 is engaged with an externally threaded portion 126 of lens cell 12. The wheel 122 is rotatably mounted to the flange 52 of focus mount 20 by a pin 128 with a threaded tip for fastening to the focus mount 20. The rotational output of the wheel 122 is transferred to barrel 120 by a gear train, as described below, and acts to rotate the barrel 120 about the central longitudinal axis 15. Rotation of the barrel 120 and wheel 122 are converted to a linear motion that displaces the lens cell 12 axially relative to the focus mount 20. As shown in FIG. 3, the flange 52 of focus mount 20 includes a bore 125 (shown in FIGS. 11 and 11A) that is dimensioned with a clearance for the adjacent portion of the lens cell 12, which protrudes into the bore 125 with a clearance that accommodates the driven axial movement.

Distributed about the outer peripheral rim of the wheel 122 are gear teeth designated as 130 in FIGS. 1 and 11 meshed with corresponding gear teeth designated as 132 in FIGS. 2 and 11A distributed about the outer peripheral rim of the barrel 120 to define the gear train. Centrally located on the wheel 122 is a coupling element, illustrated in FIGS. 1 and 11 as a hex-head structure 134. Structure 134 is engaged by the end of a suitable tool (not shown) and rotated for bi-directionally driving or moving the lens cell 12 axially relative to the focus mount 20. For example, counterclockwise rotation of structure 134 may provide a torque that is converted to a linear motion for moving the lens cell 12 axially in one direction and clockwise rotation of structure 134 provides a torque that is converted to a linear motion for moving the lens cell 12 axially in an opposite direction. Other types of driven linkages are contemplated by the invention for rotating barrel 120 relative to lens cell 12 to move the lens cell 12 relative to the focus mount 20. Projecting from the flange 52 is a shroud 136 (FIG. 3) with guide surfaces that assist in constraining and guiding the lens cell 12 to move substantially perpendicular to the focus mount 20.

While the present invention has been illustrated by a description of exemplary embodiments and while these embodiments have been described in some detail, it is not the intention of the Applicant to restrict or in any way limit the scope of the appended claims to such detail. Additional advantages and modifications will readily appear to those skilled in the art. The various features of the present invention may be used alone or in numerous combinations depending on the needs and preferences of the user. This has been a description of the present invention, along with the preferred methods of practicing the present invention as currently known. However, the invention itself should only be defined by the appended claims.

What is claimed is:

1. An optical system with an optic having first and second faces and an outer circumferential edge connecting the first and second faces, the optical system comprising:
an optic support structure having a hollow interior with a longitudinal central axis and a support surface extending around said longitudinal central axis for receiving the optic;
a resilient member carried by said optic support structure, said resilient member configured to contact the outer circumferential edge of the optic and to be moved outwardly by the contact transverse to said longitudinal central axis; and
at least one transverse alignment seat projecting axially from said support surface and positioned to contact the first face of the optic, said transverse alignment seat and said resilient member cooperating to secure the optic in said hollow interior of said optic support structure and to position the optic transverse to said longitudinal central axis.

2. The optical system of claim 1 wherein said support surface and said resilient member are positioned within a groove defined in said hollow interior of said optic support structure.

3. The optical system of claim 2 wherein said support surface and said transverse alignment seat are located on an insert received in said groove and mounted to said optic support structure.

4. The optical system of claim 1 wherein said resilient member further comprises a flexible tab member having at least a portion extending radially inward from adjacent portions of said support surface, said flexible tab configured to be resiliently biased outwardly to said longitudinal central axis when the optic is contained in said hollow interior of said optic support structure.

5. The optical system of claim 4 wherein said flexible tab member is a cantilevered member.

6. The optical system of claim 1 wherein said first transverse alignment seat is positioned diametrically across from said resilient member.

7. The optical system of claim 1 wherein said support surface further comprises:
second and third transverse alignment seats projecting from said support surface and arranged in a flanking relationship on opposite sides of said first transverse alignment seat, said second and third transverse alignment seats positioned to contact the first face of the optic.

8. The optical system of claim 7 wherein said first and second transverse alignment seats and said first and third transverse alignment seats are positioned equidistant from each other about said longitudinal central axis.

9. The optical system of claim 1 wherein said optic support structure is divided into a first housing carrying said resilient member and a second housing carrying said first transverse alignment seat, said first and second housings defining said hollow interior when joined to form said optic support structure.

10. The optical system of claim 9 wherein said support surface further comprises:
second and third transverse alignment seats projecting from said support surface and carried by said second housing, said second and third transverse alignment seats positioned to contact the first face of the optic.

11. The optical system of claim 9 further comprising:
first and second axial alignment seats carried by said second housing and arranged about said support surface, said first and second axial alignment seats contacting the outer circumferential edge of the optic.

12. The optical system of claim 1 further comprising:
first and second axial alignment seats arranged about said support surface, said first and second axial alignment seats contacting the outer circumferential edge of the optic, and said first and second axial alignment seats cooperating with said first transverse alignment seat and said resilient member to secure the optic against substantial movement in said hollow interior of said optic support structure and with said resilient member to axially position the optic relative to said support surface.

13. The optical system of claim 12 wherein said first and second axial alignment seats are positioned in a flanking relationship on opposite sides of said first transverse alignment seat.

14. An optical system with an optic having first and second faces and an outer circumferential edge connecting the first and second faces, the optical system comprising:
an optic support structure having a hollow interior with a longitudinal central axis and a first support surface extending around said longitudinal central axis for receiving the optic;
a resilient member carried by said optic support structure, said resilient member configured to contact the outer circumferential edge of the optic and to be moved outwardly by the contact transverse to said longitudinal central axis; and
first and second axial alignment seats arranged about said support surface and contacting the outer circumferential edge of the optic, and said first and second axial alignment seats cooperating with said resilient member to secure the optic against substantial movement in said hollow interior of said optic support structure and to axially position the optic relative to said support surface.

15. The optical system of claim 14, further comprising:
a plurality of transverse alignment seats each projecting axially from said support surface and positioned to contact the first face of the optic, said transverse alignment seats and said resilient member cooperating to secure the optic in said hollow interior of said optic support structure and to position the optic transverse to said longitudinal central axis.

16. The optical system of claim 15 wherein said optic support structure is divided into a first housing carrying said resilient member and a second housing carrying said first and second axial alignment seats, said first and second housings defining said hollow interior when joined to form said optic support structure.

17. An optical system having an image source, said optical system including a plurality of optics, said optical system comprising:
an optic support structure having a hollow interior with a longitudinal central axis and a plurality of mounting locations spaced apart along said longitudinal central axis, each of the mounting locations being configured to support one of the plurality of optics; and
a focus mount including a flange for mounting said optic support structure within the optical system, a driver element and a driven element operatively coupling said driver element with said optic support structure, said driven element configured to move said optic support structure along said central longitudinal axis for positioning said optic support structure relative to the image source.

18. The optical system of claim 17 wherein said driven element has a threaded engagement with said driver element so that rotation of said driver element moves said optic support structure relative to the image source.

19. The optical system of claim 18 wherein said driven element includes a first plurality of gear teeth and said driver element includes a second plurality of gear teeth enmeshed with said first plurality of gear teeth so that rotation of said driver element causes rotation of said driven element.

20. The optical system of claim 17 wherein said mounting locations inside said support structure are stationary relative to the optic support structure when said driven element is moving said optic support structure along said central longitudinal axis.

21. A method of holding an optic inside a optic support structure having a longitudinal central axis, the optic having a first half and a second half defined by a longitudinal bisecting plane, the method comprising:
contacting the first half of the optic to position the optic in a direction transverse to the longitudinal central axis;
contacting the first half of the optic to position the optic in a direction parallel to the longitudinal central axis; and
applying a force to the second half of the optic in the direction transverse to the longitudinal central axis for securing the optic against substantial movement relative to the optic support structure.

22. The method of claim 21 wherein applying the force to the second half of the optic further comprises:
contacting an outer circumferential edge of the optic with a portion of a resilient member having a spring biased attachment with the optic support structure.

23. The method of claim 21 wherein the optic has opposite first and second faces and an outer circumferential edge connecting the first and second faces, and contacting the first half of the optic to position the optic in the direction transverse to the longitudinal central axis further comprises:
contacting one of the first and second faces of the optic with transverse alignment seats.

24. The method of claim 23 wherein contacting one of the first and second faces of the optic further comprises:
contacting at least three spaced-apart points on one of the first and second faces of the optic with the transverse alignment seats.

25. The method of claim 21 wherein the optic has opposite first and second faces and an outer circumferential edge connecting the first and second faces, and contacting the first half of the optic to position the optic in the direction parallel to the longitudinal central axis further comprises:
contacting the first half of the optic on the outer circumferential edge with axial alignment seats to position the optic within the support structure in a direction parallel to the longitudinal central axis.

26. The method of claim 25 wherein contacting the outer circumferential edge of the optic further comprises:
contacting a pair of points spaced about the outer circumferential edge of the optic with the axial alignment seats.

27. An optic support structure comprising:
a hollow interior with a longitudinal central axis;
a support surface extending around said longitudinal central axis;
a resilient member carried by the optic support structure configured to be moved outwardly transverse to said longitudinal central axis; and
at least one transverse alignment seat projecting axially from said support surface, said transverse alignment seat and said resilient member configured to cooperate to secure an optic in said hollow interior of said optic support structure and to position the optic transverse to said longitudinal central axis.

28. The optic support structure of claim 27, wherein said support surface and said resilient member are positioned within a groove defined in said hollow interior of said optic support structure.

29. The optic support structure of claim 28, wherein said support surface and said transverse alignment seat are located on an insert received in said groove and mounted to said optic support structure.

30. The optic support structure of claim 27, wherein said resilient member further comprises a flexible tab member having at least a portion extending radially inward from adjacent portions of said support surface, said flexible tab configured to be resiliently biased outwardly to said longitudinal central axis.

31. The optic support structure of claim 30, wherein said flexible tab member is a cantilevered member.

32. The optic support structure of claim 27, wherein said first transverse alignment seat is positioned diametrically across from said resilient member.

33. The optic support structure of claim 27, wherein said support surface further comprises:
second and third transverse alignment seats projecting from said support surface and arranged in a flanking relationship on opposite sides of said first transverse alignment seat, said second and third transverse alignment seats configured to contact a face of an optic.

34. The optic support structure of claim 33, wherein said first and second transverse alignment seats and said first and third transverse alignment seats are positioned equidistant from each other about said longitudinal central axis.

35. The optic support structure of claim 27, wherein said optic support structure is divided into a first housing carrying said resilient member and a second housing carrying said first transverse alignment seat, said first and second housings defining said hollow interior when joined to form said optic support structure.

36. The optic support structure of claim 35, wherein said support surface further comprises:
second and third transverse alignment seats projecting from said support surface and carried by said second housing, said second and third transverse alignment seats configured to contact a face of an optic.

37. The optic support structure of claim 35, further comprising:
first and second axial alignment seats carried by said second housing and arranged about said support surface, said first and second axial alignment seats configured to contact an edge of an optic.

38. The optic support structure of claim 27, further comprising:
first and second axial alignment seats arranged about said support surface, said first and second axial alignment seats configured to contact an outer circumferential edge of an optic, and said first and second axial alignment seats configured to cooperate with said first transverse alignment seat and said resilient member to secure an optic against substantial movement in said hollow interior of said optic support structure and with said resilient member to axially position an optic relative to said support surface.

39. The optic support structure of claim 38, wherein said first and second axial alignment seats are positioned in a flanking relationship on opposite sides of said first transverse alignment seat.

40. The optic support structure of claim 27, further comprising:
a focus mount including a flange for mounting said optic support structure, a driver element and a driven element operatively coupling said driver element with said optic support structure, said driven element configured to move said optic support structure along said central longitudinal axis.

41. The optical system of claim 40, wherein said driven element has a threaded engagement with said driver element so that rotation of said driver element moves said optic support structure along said central axis.

42. The optical system of claim 40, wherein said driven element includes a first plurality of gear teeth and said driver element includes a second plurality of gear teeth enmeshed with said first plurality of gear teeth so that rotation of said driver element causes rotation of said driven element.

43. The optical system of claim 40 wherein said mounting locations inside said support structure are stationary relative to the optic support structure when said driven element is moving said optic support structure along said central longitudinal axis.

44. An optic support structure comprising:
a hollow interior with a longitudinal central axis;
a first support surface extending around said longitudinal central axis;
a resilient member carried by said optic support structure, said resilient member configured to be moved outwardly transverse to said longitudinal central axis; and
first and second axial alignment seats arranged about said support surface, said first and second axial alignment seats configured to cooperate with said resilient member to secure an optic against substantial movement in said hollow interior of said optic support structure and to axially position an optic relative to said support surface.

45. The optic support system of claim 44, further comprising:
a plurality of transverse alignment seats each projecting axially from said support surface and configured to contact a face of an optic, said transverse alignment seats and said resilient member configured to cooperate to secure an optic in said hollow interior of said optic support structure and to position an optic transverse to said longitudinal central axis.

46. The optical system of claim 45, wherein said optic support structure is divided into a first housing carrying said resilient member and a second housing carrying said first and second axial alignment seats, said first and second housings defining said hollow interior when joined to form said optic support structure.

47. The optic support structure of claim 44, further comprising:
a focus mount including a flange for mounting said optic support structure, a driver element and a driven element operatively coupling said driver element with said optic support structure, said driven element configured to move said optic support structure along said central longitudinal axis.

48. The optical system of claim 44, wherein said driven element has a threaded engagement with said driver element so that rotation of said driver element moves said optic support structure along said central axis.

49. The optical system of claim 44, wherein said driven element includes a first plurality of gear teeth and said driver element includes a second plurality of gear teeth enmeshed with said first plurality of gear teeth so that rotation of said driver element causes rotation of said driven element.

50. The optical system of claim 44, wherein said mounting locations inside said tubular support structure are stationary relative to the optic support structure when said driven element is moving said optic support structure along said central longitudinal axis.
